(19) United States
(12) Patent Application Publication
(10) Pub. No.: US 2023/0169036 A1
(43) Pub. Date: Jun. 1, 2023

(54) SYSTEM AND METHOD FOR DELETING PARENT SNAPSHOTS OF RUNNING POINTS OF STORAGE OBJECTS USING EXTENT OWNERSHIP VALUES

(71) Applicant: VMware, Inc., Palo Alto, CA (US)

(72) Inventors: Enning Xiang, San Jose, CA (US); Wenguang Wang, Santa Clara, CA (US); Yiqi Xu, Mountain View, CA (US)

(21) Appl. No.: 17/522,820

(22) Filed: Nov. 9, 2021

(51) Int. Cl. G06F 16/11

(52) U.S. Cl. CPC G06F 16/128

(57) ABSTRACT

System and method for deleting parent snapshots of running points of storage objects stored in a storage system, in response to a request to delete a parent snapshot of a running point of a storage object stored in the storage system, changes the minimum extent ownership value of the running point to the minimum extent ownership value of the parent snapshot so that any physical extent with an extent ownership value equal to or greater than the changed minimum extent ownership value is deemed to be owned by the running point. For each logical block of the parent snapshot, depending on whether the physical extent corresponding to that logical block is determined to be exclusively accessible to the parent snapshot, the physical extent is removed or no action is taken on the physical extent so that the physical extent is used by the running point.

### BACKGROUND

Snapshot technology is commonly used to preserve point-in-time (PIT) state and data of a virtual computing instance (VCI), such as a virtual machine. Snapshots of VCIs are used for various applications, such as VCI replication, VCI rollback and data protection for backup and recovery.

Current snapshot technology can be classified into two types of snapshot techniques. The first type of snapshot techniques includes redo-log based snapshot techniques, which involve maintaining changes for each snapshot in separate redo logs. A concern with this approach is that the snapshot technique cannot be scaled to manage a large number of snapshots, for example, hundreds of snapshots. In addition, this approach requires intensive computations to consolidate across different snapshots.

The second type of snapshot techniques includes tree-based snapshot techniques, which involve creating a chain or series of snapshots to maintain changes to the underlying data using a B tree structure, such as a B+ tree structure. Significant advantage of the tree-based snapshot techniques over the redo-log based snapshot techniques is the scalability of the tree-based snapshot techniques. However, the snapshot B tree structures of the tree-based snapshot techniques may include many nodes that are shared by multiple snapshots. Thus, physical extents in physical storage where the nodes of the snapshot B tree structures are written may be shared by multiple snapshots. Consequently, the physical extents for the snapshot B tree structures need to be efficiently managed, especially when the snapshots are selectively deleted.

### BRIEF DESCRIPTION OF THE DRAWINGS

FIG. 1 is a block diagram of a distributed storage system in which embodiments of the invention may be implemented.

FIGS. 2A-2C illustrate a copy-on-write (COW) B+ tree structure for metadata of one storage object managed by a host computer in the distributed storage system of FIG. 1 in accordance with an embodiment of the invention.

FIG. 3 illustrates a hierarchy of snapshots for a storage object in accordance with an embodiment of the invention.

FIG. 4 illustrates a snapshot manager, which may reside in each VSAN module of host computers in the distributed storage system of FIG. 1, that manages snapshots of storage objects in accordance with an embodiment of the invention.

FIG. 5 is a flow diagram of an operation executed by a snapshot manager to delete the parent snapshot of the running point of a storage object in accordance with an embodiment of the invention.

FIG. 6 is a block diagram of components of the VSAN module in accordance with an embodiment of the invention.

FIG. 7 is a flow diagram of a computer-implemented method for deleting parent snapshots of running points of storage objects stored in a storage system in accordance with an embodiment of the invention.

Throughout the description, similar reference numbers may be used to identify similar elements.

### DETAILED DESCRIPTION

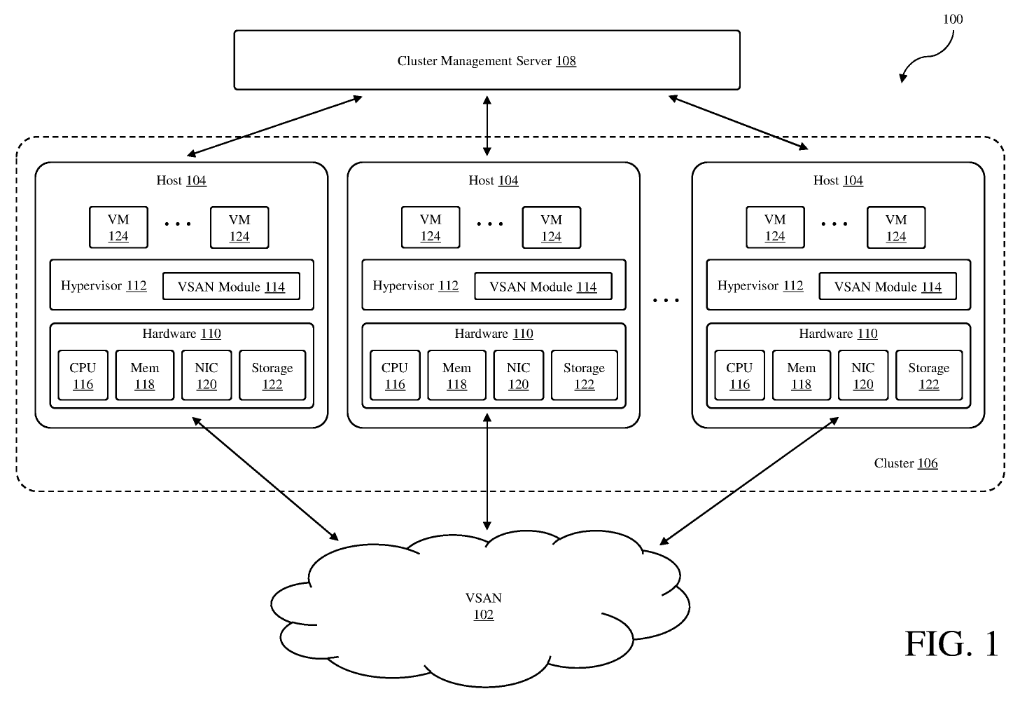

FIG. 1 illustrates a distributed storage system 100 with a storage system 102 in which embodiments of the invention may be implemented. In the illustrated embodiment, the storage system 102 is implemented in the form of a software-based “virtual storage area network” (VSAN) that leverages local storage resources of host computers 104, which are part of a logically defined cluster 106 of host computers that is managed by a cluster management server 108 in the distributed storage system 100. The VSAN 102 allows local storage resources of the host computers 104 to be aggregated to form a shared pool of storage resources, which allows the host computers 104, including any virtual computing instances (VCIs) running on the host computers, to use the shared storage resources. In particular, the VSAN 102 may be used to store and manage series of snapshots for storage objects, which may be any type of storage objects that can be stored on physical storage, such as files (e.g., virtual disk files), folders and volumes, in an efficient manner, as described herein.

As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

The cluster management server 108 of the distributed storage system 100 operates to manage and monitor the cluster 106 of host computers 104. The cluster management server 108 may be configured to allow an administrator to create the cluster 106, add host computers to the cluster and delete host computers from the cluster. The cluster management server 108 may also be configured to allow an administrator to change settings or parameters of the host computers in the cluster regarding the VSAN 102, which is formed using the local storage resources of the host computers in the cluster. The cluster management server 108 may further be configured to monitor the current configurations of the host computers and any VCIs running on the host computers, for example, VMs. The monitored configurations may include hardware and/or software configurations of each of the host computers. The monitored configurations may also include VCI hosting information, i.e., which VCIs (e.g., VMs) are hosted or running on which host computers. The monitored configurations may also include information regarding the VCIs running on the different host computers in the cluster.

The cluster management server 108 may also perform operations to manage the VCIs and the host computers 104 in the cluster 106. As an example, the cluster management server 108 may be configured to perform various resource management operations for the cluster, including VCI placement operations for either initial placement of VCIs and/or load balancing. The process for initial placement of VCIs, such as VMs, may involve selecting suitable host computers for placement of the virtual instances based on, for example, memory and central processing unit (CPU) requirements of the VCIs, the current memory and CPU loads on all the host computers in the cluster, and the memory and CPU capacity of all the host computers in the cluster.

In some embodiments, the cluster management server 108 may be a physical computer. In other embodiments, the cluster management server may be implemented as one or more software programs running on one or more physical computers, such as the host computers 104 in the cluster 106, or running on one or more VCIs, which may be hosted on any host computers. In an implementation, the cluster management server is a VMware vCenter™ server with at least some of the features available for such a server.

As illustrated in FIG. 1, each host computer 104 in the cluster 106 includes hardware 110, a hypervisor 112, and a VSAN module 114. The hardware 110 of each host computer includes hardware components commonly found in a physical computer system, such as one or more processors 116, one or more system memories 118, one or more network interfaces 120 and one or more local storage devices 122 (collectively referred to herein as “local storage”). Each processor 116 can be any type of a processor, such as a CPU commonly found in a server. In some embodiments, each processor may be a multi-core processor, and thus, includes multiple independent processing units or cores. Each system memory 118, which may be random access memory (RAM), is the volatile memory of the host computer 104. The network interface 120 is an interface that allows the host computer to communicate with a network, such as the Internet. As an example, the network interface may be a network interface card (NIC). Each local storage device 122 is a nonvolatile storage, which may be, for example, a solid-state drive (SSD) or a magnetic disk.

The hypervisor 112 of each host computer 104, which is a software interface layer, enables sharing of the hardware resources of the host computer by VMs 124, running on the host computer using virtualization technology. With the support of the hypervisor 112, the VMs provide isolated execution spaces for guest software. In other embodiments, the hypervisor may be replaced with an appropriate virtualization software to support a different type of VCIs.

The VSAN module 114 of each host computer 104 provides access to the local storage resources of that host computer (e.g., handle storage input/output (I/O) operations to data objects stored in the local storage resources as part of the VSAN 102) by other host computers 104 in the cluster 106 or any software entities, such as VMs 124, running on the host computers in the cluster. As an example, the VSAN module of each host computer allows any VM running on any of the host computers in the cluster to access data stored in the local storage resources of that host computer, which may include virtual disks (or portions thereof) of VMs running on any of the host computers and other related files of those VMs. In addition, the VSAN module generates and manages snapshots of storage objects, such as virtual disk files of the VMs, in an efficient manner.

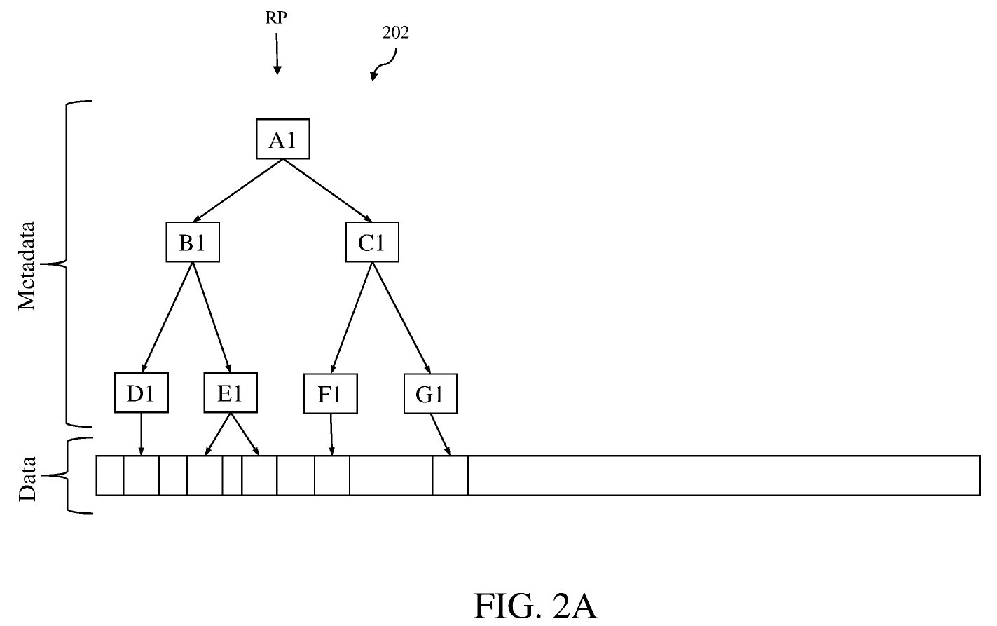

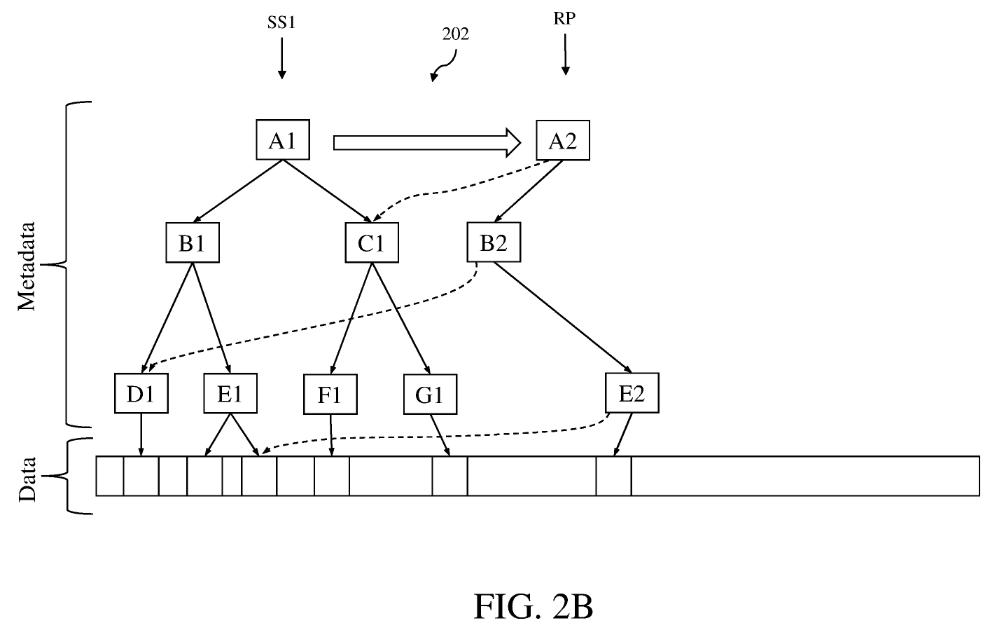

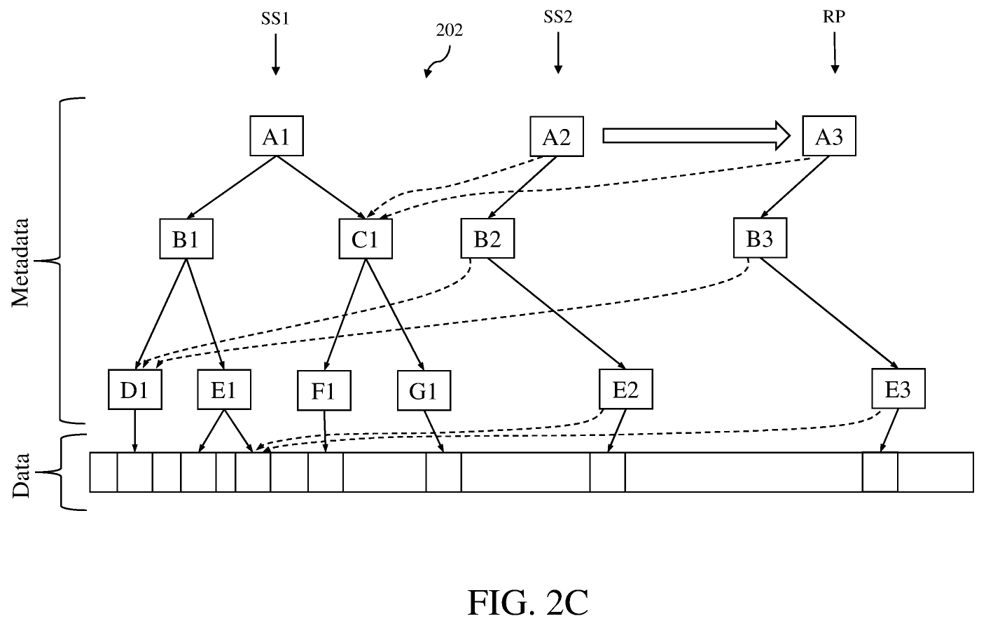

In an embodiment, the VSAN module 114 leverages B tree structures, such as copy-on-write (COW) B+ tree structures, to organize storage objects and their snapshots taken at different times. An example of a COW B+ tree structure for one storage object managed by the VSAN module 114 in accordance with an embodiment of the invention is illustrated in FIGS. 2A-2C. In this embodiment, the storage object includes data, which is the actual data of the storage object, and metadata, which is information regarding the COW B+ tree structure used to store the actual data in the VSAN 102.

FIG. 2A shows the storage object before any snapshots of the storage object were taken. The storage object comprises data, which is stored in data blocks in the VSAN 102, as defined by a COW B+ tree structure 202. Currently, the B+ tree structure 202 includes nodes A1-G1, which define one tree of the B+ tree structure (or one sub-tree if the entire B+ tree structure is viewed as being a single tree). The node A1 is the root node of the tree. The nodes B1 and C1 are index nodes of the tree. The nodes D1-G1 are leaf nodes of the tree, which are nodes on the bottom layer of the tree. As snapshots of the storage object are created, more root, index and leaf nodes, and thus, more trees may be created. Each root node contains references that point to index nodes. Each index node contains references that point to other nodes. Each leaf node records the mapping from logic block address (LBA) to the physical location or address in the storage system. Each node in the B+ tree structure may include a node header and a number of references or entries. Each entry in the leaf nodes may include an LBA, physical extent location, checksum and other characteristics of the data for this entry. In a particular implementation, the physical extent location, checksum and other characteristics of the data for each entry are offloaded to a middle logical map to save space efficiency when one middle logical map extent is shared by multiple logical map extents. The middle logical map is described in more detail below. In FIG. 2A, the entire B+ tree structure 202 can be viewed as the current state or running point (RP) of the storage object and not shared with any ancestor snapshots. Thus, the nodes A1-G1 are exclusive owned by the running point and are modifiable. Consequently, the nodes A1-G1 can be updated without copying out new leaf nodes.

FIG. 2B shows the storage object after a first snapshot SS1 of the storage object was taken. Once the first snapshot SS1 is created or taken, all the nodes in the B+ tree structure 202 become immutable (i.e., cannot be modified). In FIG. 2B, the nodes A1-G1 have become immutable, preserving the storage object to a point in time when the first snapshot SS1 was taken. Thus, the tree with the nodes A1-G1 can be viewed as the first snapshot SS1. In some embodiments, each snapshot of a storage object may include a snapshot generation ID and data regarding all the nodes in the B+ tree structure for that snapshot, e.g., the nodes A1-G1 of the B+ tree structure 202 for the first snapshot SS1 in the example shown in FIG. 2B.

When a modification of the storage object is made, after the first snapshot SS1 is created, a new root node and one or more index and leaf nodes are created. In FIG. 2B, new nodes A2, B2 and E2 have been created after the first snapshot SS1 was taken, which now define the running point of the storage object. Thus, the nodes A2, B2 and E2, as well as the nodes C1, D1, F1 and G1, which are common nodes for both the first snapshot SS1 and the current running point, represent the current state of the storage object.

In FIG. 2B, the leaf node E2 of the COW B+ tree structure 202 is exclusively owned by the running point and not shared with any ancestor snapshots, e.g., the snapshot SS1. Thus, the leaf node E2 can be updated without copying out a new leaf node. However, the leaf node D1 is shared by the running point and the snapshot SS1, which is the parent snapshot of the running point. Thus, in order to revise or modify the leaf node D1, a copy of the leaf node D1 must be made as a new leaf node that is exclusively owned by the running point, which can then be revised or modified.

FIG. 2C shows the storage object after a second snapshot SS2 of the storage object was taken. As noted above, once a snapshot is created or taken, all the nodes in the B+ tree structure become immutable. Thus, in FIG. 2C, the nodes A2, B2 and E2 have become immutable, preserving the storage object to a point in time when the second snapshot SS2 was taken. Thus, the tree with the nodes A2, B2, E2, C1, D1, F1 and G1 can be viewed as the second snapshot. When a modification of the storage object is made after the second snapshot SS2 is created, a new root node and one or more index and leaf nodes are created. In FIG. 2C, new nodes A3, B3 and E3 have been created after the second snapshot was taken. Thus, nodes A3, B3 and E3, as well as the nodes C1, D1, F1 and G1, which are common nodes for both the second snapshot and the current running point, represent the current state of the storage object.

In FIG. 2C, the leaf node E3 of the COW B+ tree structure 202 is exclusively owned by the running point and not shared with any ancestor snapshots, e.g., the snapshots SS1 and SS2. Thus, the leaf node E3 can be updated without copying out a new leaf node. However, the leaf nodes D1, F1 and G1 are shared by the running point and the snapshots SS1 and SS2. Thus, in order to revise or modify any of these shared leaf nodes, a copy of the original leaf node must be made as a new leaf node that is exclusively owned by the running point, which can then be revised or modified.

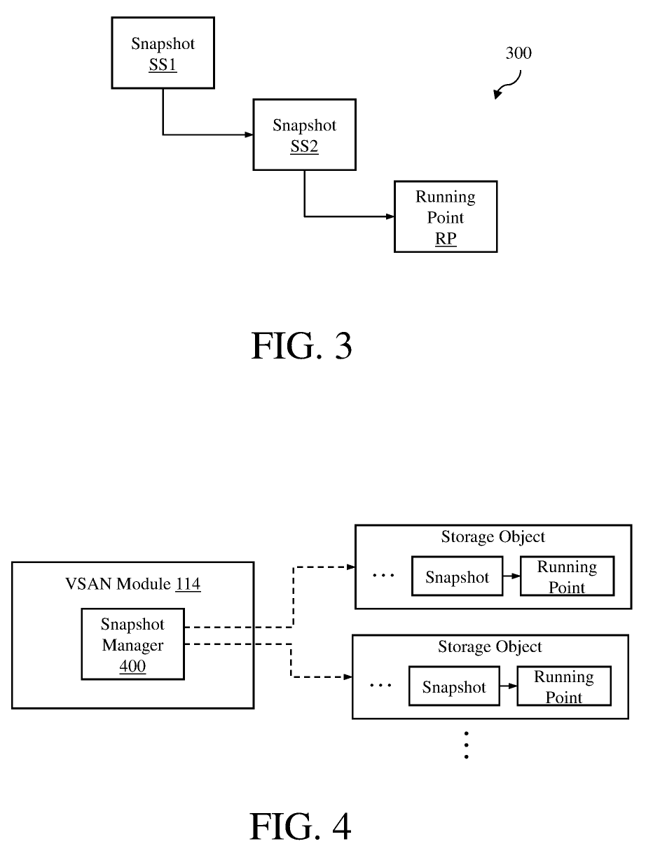

In this manner, multiple snapshots of a storage object can be created at different times. These multiple snapshots create a hierarchy of snapshots. FIG. 3 illustrates a hierarchy 300 of snapshots for the example described above with respect to FIGS. 2A-2C. As shown in FIG. 3, the hierarchy 300 includes the first snapshot SS1, the second snapshot SS2 and the running point RP. The first snapshot SS1 is the parent snapshot of the second snapshot SS2, which is the parent snapshot of the running point RP or the current state. Thus, the snapshot hierarchy 300 illustrates how snapshots of a storage object can be visualized.

As more COW B+ tree snapshots are created for a storage object, e.g., a virtual disk of a virtual machine, more nodes are shared by the various snapshots. The nodes of the COW B+ tree structure, including the shared nodes, are stored in physical extents, which are one or more contiguous data blocks of physical storage, such as physical disks. Thus, the same physical extents may be shared by multiple snapshots. When a snapshot is being deleted, the physical extents associated with the snapshot, i.e., accessible to the snapshot, may be removed depending on the sharing status of the physical extents, as described below.

In an embodiment, as illustrated in FIG. 4, each VSAN module 114 in the distributed storage system 100 includes a snapshot manager 400 that manages snapshots of storage objects that are handled or owned by that VSAN module. In order to manage the snapshots of storage objects, a single logical map is maintained for each snapshot, which provides mapping between logical block addresses (LBAs), i.e., addresses of logical blocks, and physical block addresses (PBAs) of physical extents, which are used to store the snapshot data, including the running point data. Thus, the physical extents in the single logical map are the physical extents that are accessible to the snapshot. In an embodiment, middle logical block addresses (MBAs) may be used to map between the LBAs and the PBAs. In this embodiment, in addition to a logical map for each snapshot, a middle logical map is maintained for all the snapshots and the running point, where each logical map provides mapping between the LBAs and the MBAs and the middle logical map provides mapping between the MBAs and the PBAs. In a particular implementation, the schema of the logical map is as follows:
Key: LBA
Value: [MBA, number of blocks, etc.]
Similarly, the schema of the middle logical map is as follows:
Key: MBA
Value: [PBA, number of blocks, cyclic redundancy check (crc), etc.]

In an embodiment, the logical maps and middle logical map may be stored in B tree structures. In a particular implementation, the logical maps are stored in a COW B+ tree structure, as illustrated in FIGS. 2A-2C, and the middle logical map is stored in a normal B+ tree structure. However, in other embodiments, the logical maps and middle logical maps may be stored in any data structures.

In some embodiments, a performance-efficient method is used to manage the shared status of physical extents in the distributed storage system 100. In these embodiments, each physical extent is assigned with a monotonically increased sequence value, e.g., a monotonically increased sequence number, which is used as extent ownership value. In some embodiments, MBA values are used as the extent ownership values, as described herein. However, in other embodiments, the extent ownership values may be any monotonically increased sequence values, which are assigned to or associated with the physical extents. In some embodiments, the monotonically increased sequence values may include alphanumeric characters or exclusively numbers. In the embodiments where MBA values are used as extent ownership values, each snapshot is assigned with a minimum extent ownership value, i.e., minMBA, the minimum MBA of all physical extents owned by the snapshot. In addition, each physical extent has the following property: the physical extent accessible to a snapshot and whose physical extent MBA is smaller than the minMBA of the snapshot is shared between the snapshot and its parent snapshot. Relying on this property, the system can quickly determine the shared status of a physical extent to be overwritten for write requests at the running point (i.e., the current state of a storage object). Unshared physical extents are reused for updates. However, shared physical extents are copied out first to new physical extents, which are then used for updates. This approach is more performance efficient than some state-of-art methods, such as shared bits, to manage the shared status of physical extents since no input/output (IO) is required to update the shared status of each physical extent individually.

When deleting a snapshot, the physical extents exclusively owned by the snapshot can be removed. Physical extents shared with the child snapshot may be unlinked from the snapshot being deleted, but the physical extents themselves should be kept for the child snapshot. For the shared physical extents that have been unlinked from the snapshot being deleted, these physical extents cannot be updated in-place since the physical extents are needed as is for the child snapshot. Thus, in order to update these extents, new physical extents should be created for modification. However, there is a problem when the parent snapshot of the running point is being deleted with respect to the physical extents shared between the parent snapshot and the running point. Unlike the other unlinked shared physical extents, parent snapshot physical extents shared with the running point that have been unlinked should be reused for updates, i.e., updated in-place rather than a new physical extent being created. Thus, there is a need to identify shared physical extents that have been unlinked from the parent snapshot of the running point for deletion of the parent snapshot.

In the distributed storage system 100, the snapshot manager 400 of each VSAN module 114 in the respective host computer 104 is able to properly manage shared physical extents that have been unlinked from the parent snapshot of the running point of a storage object, which is being handled by that VSAN module, when the parent snapshot is being deleted. In an embodiment, when the snapshot manager starts to delete the parent snapshot of the running point of a storage object, the snapshot manager will transfer the ownership of all physical extents owned by the parent snapshot to the running point immediately. This is achieved by updating the minMBA of the running point to the minMBA of the parent snapshot. After the ownership of all physical extents previously owned by the parent snapshot is transferred to the running point, any overwrite related to such physical extents at the running point will be executed in-place.

For the physical extents of the parent snapshot being deleted, the snapshot manager checks whether the physical extents are exclusively accessible to the parent snapshot. In an embodiment, all physical extents exclusively accessible to the parent snapshot can be checked efficiently by iterating all physical extents in the snapshot logical map and the running point logical map in parallel to find the difference. A physical extent is exclusively accessible to the parent snapshot if the extent ownership value assigned to the physical extent, e.g., MBA of the physical extent, is only found in the snapshot logical map. Thus, a physical extent is not exclusively accessible to the parent snapshot if the extent ownership value assigned to the physical extent is found in both the snapshot logical map and the running point logical map. Each physical extent accessible to the parent snapshot but not accessible to the running point needs to be removed in the course of the snapshot physical deletion. These physical extents are not accessible to the running point (namely, these physical extents are exclusively owned by the parent snapshot) and cannot be accessed for any client request, so it is safe to delete the physical extent. For the physical extent that is accessible to both the running point and the parent snapshot, the snapshot manager will just leave the physical extent as it is since this physical extent is already owned by the running point and its lifecycle will be managed by the running point. In this way, physical extents exclusively owned by the parent snapshot being deleted are removed and the logical map of the running point is kept intact. This deletion operation of the parent snapshot of the running point of a storage object is described in more detail below.

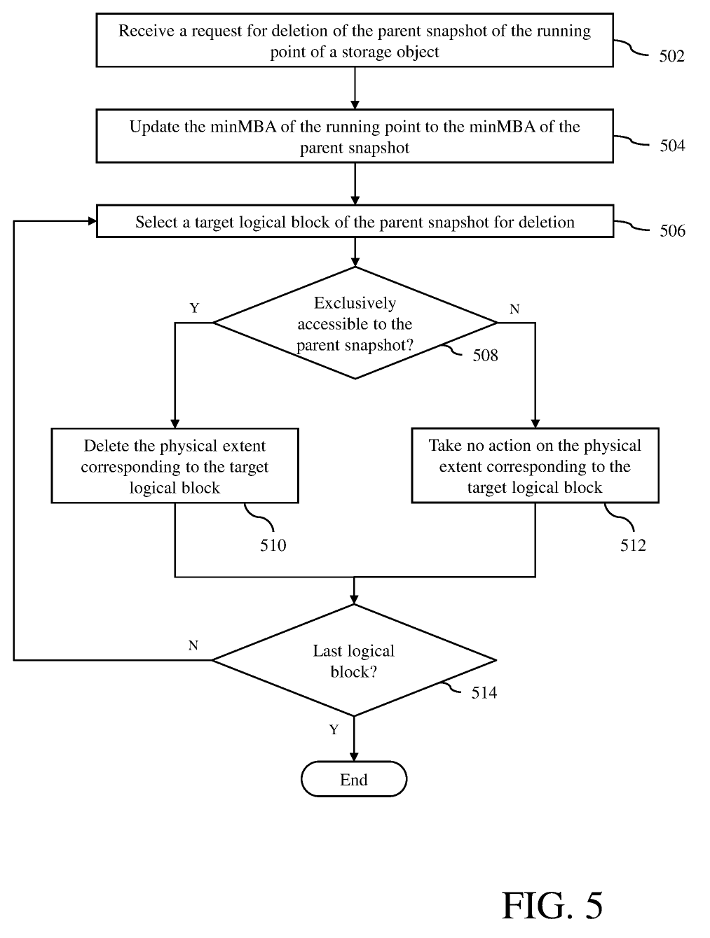

An operation executed by a particular snapshot manager 400 in the distributed storage system 100 to delete the parent snapshot of the running point of a storage object in accordance with an embodiment is described with reference to a process flow diagram of FIG. 5. In this embodiment, MBAs are used as extent ownership values. Thus, minMBAs are used as minimum extent ownership values for the parent snapshot and the running point.

The operation begins at step 502, where a request for deletion of the parent snapshot of the running point of the storage object is received at the snapshot manager 400. The deletion request may have originated from a user input or a software process running on any of the host computers 104 in the storage system 100. In an embodiment, the cluster manager server 108 may be used to enter the deletion request by the user, such as an administrator.

Next, at step 504, the minMBA of the running point is updated to the minMBA of the parent snapshot by the snapshot manager 400. That is, the minMBA of the running point is changed from its previous value to the minMBA of the parent snapshot. As a result, any physical extent with an MBA value equal to or greater than the new minMBA value of the running point will be deemed to be owned by the running point. Thus, if any logical block is overwritten that has an MBA value equal to or larger than the new minMBA value of the running point, the physical extent corresponding to the logical block is reused. However, if any logical block is overwritten that has an MBA value smaller than the new minMBA value of the running point, the physical extent is copied to a new physical extent and the new physical extent is updated.

Next, at step 506, a target logical block of the parent snapshot is selected for deletion by the snapshot manager 400. In an embodiment, the target logical block may be selected based on an order of increasing or decreasing block numbers, e.g., LBAs. Thus, if the logical block is selected based on an order of increasing block numbers, the logical block of the parent snapshot with the lowest block number that has not yet been processed for deletion is selected. In another embodiment, the target logical block may be randomly selected from the logical blocks of the parent snapshot that have not yet been processed for deletion.

Next, at step 508, a determination is made by the snapshot manager 400 whether the physical extent corresponding to the target logical block is exclusively accessible to the parent snapshot. In an embodiment, this determination can be efficiently made by iterating through all MBAs, which are assigned to the physical extents, in the parent snapshot logical map and the running point logical map in parallel to find MBAs that are only in the parent snapshot logical map. That is, if an MBA is found only in the parent snapshot logical map, then the physical extent assigned to that MBA is exclusively accessible to the parent snapshot.

If the physical extent corresponding to the target logical block is exclusively accessible to the parent snapshot, the operation proceeds to step 510, where the physical extent corresponding to the target logical block is deleted, e.g., all data in the physical extent is actually deleted or may be considered to have been deleted. Any physical extent accessible to the parent snapshot of the running point but not accessible to the running point needs to be removed in the course of the deletion of the parent snapshot. These physical extents are not accessible to the running point and cannot be accessed for any client request. Thus, it is safe to delete such physical extents.

However, if the physical extent corresponding to the target logical block is not exclusively accessible to the parent snapshot, i.e., shared by both the parent snapshot and the running point, the operation proceeds to step 512, where no action is taken on the physical extent corresponding to the target logical block, i.e., the physical extent is left as is. Such physical extent is already owned by the running point, and thus, its lifecycle will be managed by the running point. Thus, the physical extent will be reused for any updates by the running point.

Next, at step 514, a determination is made by the snapshot manager 400 whether the current logical block being processed is the last logical block of the parent snapshot. If no, then the operation proceeds back to step 508 to select the next logical block of the parent snapshot of the running point to process. However, if the current logical block is the last logical block of the parent snapshot, then the operation comes to an end.

In other embodiments, rather than processing one logical block of the parent snapshot of the running point of the storage object at a time, multiple logical blocks of the parent snapshot of the running point may be processed in parallel to delete physical extents that correspond to the logical blocks that are only accessible to the parent snapshot of the running point. In other embodiments, all the logical blocks of the parent snapshot of the running point that are only accessible to the parent snapshot of the running point may be found first and then the physical extents that correspond to those logical blocks may be deleted.

The deletion operation of the parent snapshot of the running point of a storage object is further described using an example with the following layout of physical extents for the running point and its parent snapshot at t=T0:

| | | | | |
|---|---|---|---|---|
| | Block 0 | Block 1 | Block 2 | Block 3 |
| Parent Snapshot | [M0] | [M1] | [M2] | [M3] |
| Running Point | [--] | [--] | [--] | [--] |

In this example, four logical blocks of the running point and its parent snapshot, i.e., block 0, block 1, block 2 and block 3, are illustrated with physical extent associations, if any. Also, in this example, the minMBA of the parent snapshot is M0, and the minMBA of the running point is M4. As shown in the above table, blocks 0, 1, 2 and 3 were written at the parent snapshot with middle block addresses (MBAs) M0, M1, M2 and M3, respectively. As used herein, [Mx] means that the block was written and associated with the mapping extent Mx, and [--] means that the block has not been written at the parent snapshot or the running point. Thus, in this example, MBAs are used as the extent ownership values.

The logical map of the parent snapshot maintains the mapping between each logical block and its MBA (which is mapped to a corresponding PBA) for the four (4) written blocks. The logical map of the running point also contains the mapping between each logical block and its MBA (which is also mapped to a corresponding PBA) for these four (4) written blocks.

At t=T1, the logical block 0 is overwritten in the running point. The logical block 0 has an MBA value of M0, which is smaller than the minMBA of the running point, which is M4. Thus, the block 0 is shared by the running point and its parent snapshot, and a new physical extent associated with M4 is created to hold the mapping for data of the logical block 0. As a result, M4 will be referenced in the logical map of the running point instead of M0, as illustrated in the following table.

| | | | | |
|---|---|---|---|---|
| | Block 0 | Block 1 | Block 2 | Block 3 |
| Parent Snapshot | [M0] | [M1] | [M2] | [M3] |
| Running Point | [M4] | [--] | [--] | [--] |

This process of overwriting the logical block 0 can be illustrated using examples of logical maps of the running point and its parent snapshot. In this example, before creating the physical extent associated with M4, the logical maps of the parent snapshot and the running point are as follows:
parent snapshot logical map: <key = LBA0, value = [MBA = M0, numBlks = 1]>, ...
running point logical map: <key = LBA0, value = [MBA = M0, numBlks = 1]>,...
After creating the physical extent associated with M4, the logical maps of the parent snapshot and the running point are as follows:
parent snapshot logical map: <key = LBA0, value = [MBA = M0, numBlks = 1]>, ...
running point logical map: <key = LBA0, value = [MBA = M4, numBlks = 1]>,...

At t=T2, the snapshot manager for the storage object starts to delete the parent snapshot of the running point in response to an instruction to delete the parent snapshot, which may be initiated by a user or a process running in the distributed storage system 100. As a result, the minMBA of the running point is updated to M0 from M4. However, the layout of the extents for the parent snapshot and the running point has not changed, as illustrated in the following table.

| | | | | |
|---|---|---|---|---|
| | Block 0 | Block 1 | Block 2 | Block 3 |
| Parent Snapshot | [M0] | [M1] | [M2] | [M3] |
| Running Point | [M4] | [--] | [--] | [--] |

At t=T3, the logical block 1 of the parent snapshot is overwritten. In this scenario, since the MBA value of M1 for the block 1 is larger than the minMBA of the running point, which is M0, the block 1 is deemed to be owned by the running point and the extent with M1 is reused, as illustrated in the following table.

| | | | | |
|---|---|---|---|---|
| | Block 0 | Block 1 | Block 2 | Block 3 |
| Parent Snapshot | [M0] | [M1] | [M2] | [M3] |
| Running Point | [M4] | [--] | [--] | [--] |

At t=T4, the snapshot manager starts to process the first logical block of the parent snapshot, i.e., the logical block 0, to determine whether the physical extent mapped to the logical block should be removed or not. Since the physical extent with M0 for the logical block 0 is not accessible to the running point, i.e., exclusively accessible to the parent snapshot being deleted, the physical extent with M0 will be removed, as illustrated in the following table.

| | | | | |
|---|---|---|---|---|
| | Block 0 | Block 1 | Block 2 | Block 3 |
| Parent Snapshot | [--] | [M1] | [M2] | [M3] |
| Running Point | [M4] | [--] | [--] | [--] |

At t=T5, the snapshot manager starts to process the rest of the logical blocks of the parent snapshot, i.e., the logical blocks 1, 2 and 3, to determine whether these block should be removed or not. Since the physical extents with M1, M2 and M3 for the logical blocks 1, 2 and 3 are accessible to the running point, i.e., not exclusively accessible to the parent snapshot being deleted, these physical data blocks will be left alone as is, i.e., the physical extents will not be removed, as illustrated in the following table.

| | | | | |
|---|---|---|---|---|
| | Block 0 | Block 1 | Block 2 | Block 3 |
| Parent Snapshot | [--] | [--] | [--] | [--] |
| Running Point | [M4] | [M1] | [M2] | [M3] |

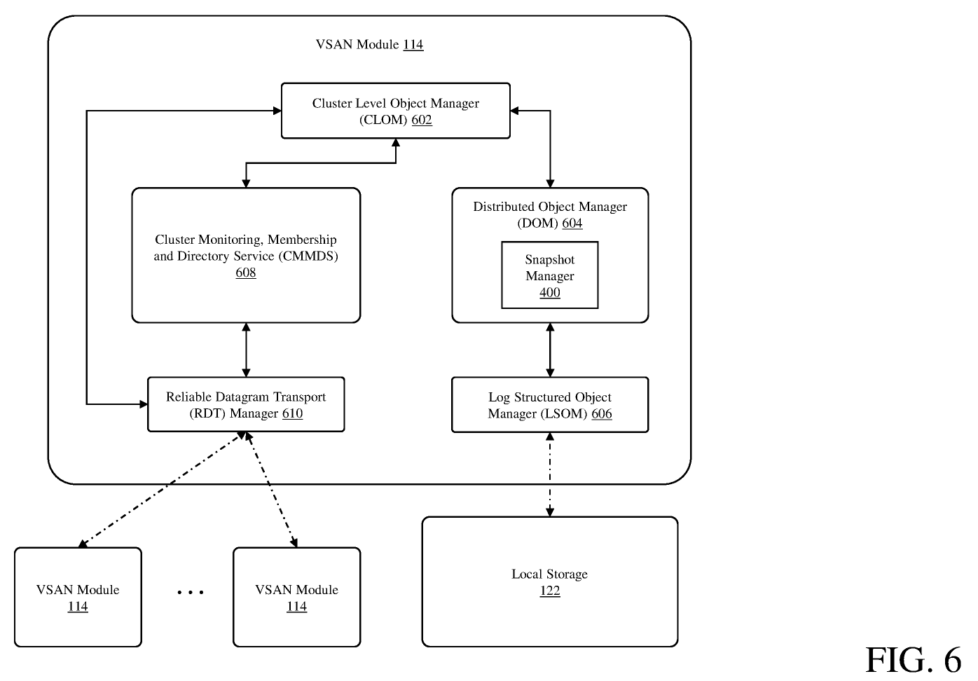

Turning now to FIG. 6, components of the VSAN module 114, which is included in each host computer 104 in the cluster 106, in accordance with an embodiment of the invention are shown. As illustrated in FIG. 6, the VSAN module includes a cluster level object manager (CLOM) 602, a distributed object manager (DOM) 604, a local log structured object management (LSOM) 606, a cluster monitoring, membership and directory service (CMMDS) 608, and a reliable datagram transport (RDT) manager 610. These components of the VSAN module may be implemented as software running on each of the host computers in the cluster.

The CLOM 602 operates to validate storage resource availability, and the DOM 604 operates to create components and apply configuration locally through the LSOM 606. The DOM 604 also operates to coordinate with counterparts for component creation on other host computers 104 in the cluster 106. All subsequent reads and writes to storage objects funnel through the DOM 604, which will take them to the appropriate components. The LSOM 606 operates to monitor the flow of storage I/O operations to the local storage 122, for example, to report whether a storage resource is congested. The CMMDS 608 is responsible for monitoring the VSAN cluster’s membership, checking heartbeats between the host computers in the cluster, and publishing updates to the cluster directory. Other software components use the cluster directory to learn of changes in cluster topology and object configuration. For example, the DOM uses the contents of the cluster directory to determine the host computers in the cluster storing the components of a storage object and the paths by which those host computers are reachable.

The RDT manager 610 is the communication mechanism for storage-related data or messages in a VSAN network, and thus, can communicate with the VSAN modules 114 in other host computers 104 in the cluster 106. As used herein, storage-related data or messages (simply referred to herein as “messages”) may be any pieces of information, which may be in the form of data streams, that are transmitted between the host computers 104 in the cluster 106 to support the operation of the VSAN 102. Thus, storage-related messages may include data being written into the VSAN 102 or data being read from the VSAN 102. In an embodiment, the RDT manager uses the Transmission Control Protocol (TCP) at the transport layer and it is responsible for creating and destroying on demand TCP connections (sockets) to the RDT managers of the VSAN modules in other host computers in the cluster. In other embodiments, the RDT manager may use remote direct memory access (RDMA) connections to communicate with the other RDT managers.

As illustrated in FIG. 6, the snapshot manager 400 for the VSAN 114 is located in the DOM 604 to perform the operation described above with respect to the flow diagram of FIG. 5. However, in other embodiments, the snapshot manager may be located elsewhere in each of the host computers 104 in the cluster 106 to perform the operation described herein.

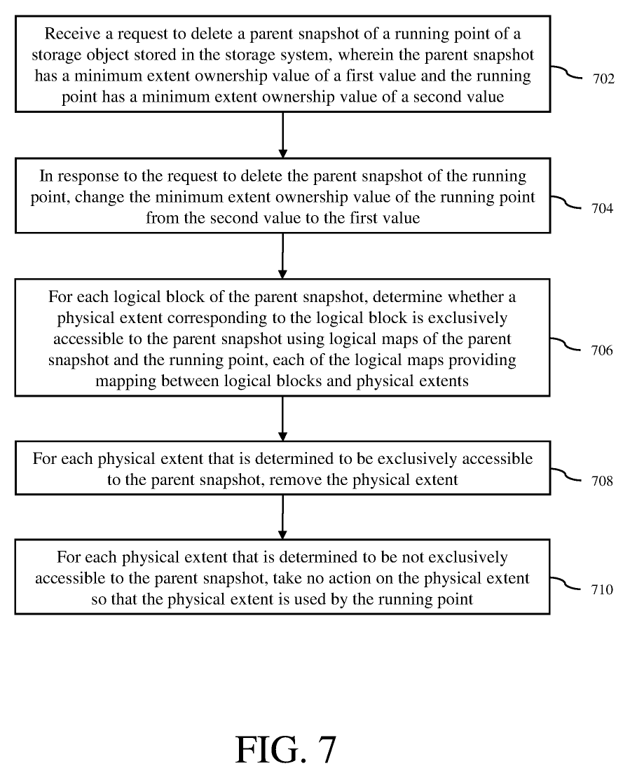

A computer-implemented method for deleting parent snapshots of running points of storage objects stored in a storage system in accordance with an embodiment of the invention is described with reference to a flow diagram of FIG. 7. At block 702, a request to delete a parent snapshot of a running point of a storage object stored in the storage system is received. The parent snapshot has a minimum extent ownership value of a first value and the running point has a minimum extent ownership value of a second value. At block 704, in response to the request to delete the parent snapshot of the running point, the minimum extent ownership value of the running point is changed from the second value to the first value so that any physical extent with an extent ownership value equal to or greater than the first value is deemed to be owned by the running point. At block 706, for each logical block of the parent snapshot, a determination is made whether a physical extent corresponding to the logical block is exclusively accessible to the parent snapshot using logical maps of the parent snapshot and the running point. Each of the logical maps providing mapping between logical blocks and physical extents. At block 708, for each physical extent that is determined to be exclusively accessible to the parent snapshot, the physical extent is removed. At block 710, for each physical extent that is determined to be not exclusively accessible to the parent snapshot, no action is taken on the physical extent so that the physical extent is used by the running point.

The components of the embodiments as generally described in this document and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for deleting parent snapshots of running points of storage objects stored in a storage system, the method comprising:
receiving a request to delete a parent snapshot of a running point of a storage object stored in the storage system, wherein the parent snapshot has a minimum extent ownership value of a first value and the running point has a minimum extent ownership value of a second value;
in response to the request to delete the parent snapshot of the running point, changing the minimum extent ownership value of the running point from the second value to the first value so that any physical extent with an extent ownership value equal to or greater than the first value is deemed to be owned by the running point;
for each logical block of the parent snapshot, determining whether a physical extent corresponding to the logical block is exclusively accessible to the parent snapshot using logical maps of the parent snapshot and the running point, each of the logical maps providing mapping between logical blocks and physical extents;
for each physical extent that is determined to be exclusively accessible to the parent snapshot, removing the physical extent; and
for each physical extent that is determined to be not exclusively accessible to the parent snapshot, taking no action on the physical extent so that the physical extent is used by the running point.

2. The method of claim 1, wherein the extent ownership value for each physical extent is a monotonically increased value.

3. The method of claim 1, wherein determining whether the physical extent corresponding to the logical block is exclusively accessible to the parent snapshot includes determining whether the extent ownership value of the logical block is found only in the logical map of the parent snapshot.

4. The method of claim 1, wherein the logical map of the parent snapshot includes extent ownership values assigned to physical extents accessible to the parent snapshot and the logical blocks of the parent snapshot corresponding to the extent ownership values.

5. The method of claim 1, wherein the extent ownership value for each physical extent is a middle block address that maps a logical block address of a particular logical block to a physical block address of a particular physical extent.

6. The method of claim 5, wherein the logical map of the parent snapshot includes middle block addresses assigned to physical extents accessible to the parent snapshot and the logical blocks of the parent snapshot corresponding to the middle block addresses.

7. The method of claim 6, wherein the logical map of the parent snapshot is associated with a middle logical map that provides mapping between the middle block addresses in the logical map of the parent snapshot and physical block addresses of physical extents accessible to the parent snapshot.

8. The method of claim 1, wherein the logical maps of the parent snapshot and the running point are stored in a B tree structure.

9. A non-transitory computer-readable storage medium containing program instructions for deleting parent snapshots of running points of storage objects stored in a storage system, wherein execution of the program instructions by one or more processors of a computer system causes the one or more processors to perform steps comprising:
receiving a request to delete a parent snapshot of a running point of a storage object stored in the storage system, wherein the parent snapshot has a minimum extent ownership value of a first value and the running point has a minimum extent ownership value of a second value;
in response to the request to delete the parent snapshot of the running point, changing the minimum extent ownership value of the running point from the second value to the first value so that any physical extent with an extent ownership value equal to or greater than the first value is deemed to be owned by the running point;
for each logical block of the parent snapshot, determining whether a physical extent corresponding to the logical block is exclusively accessible to the parent snapshot using logical maps of the parent snapshot and the running point, each of the logical maps providing mapping between logical blocks and physical extents;
for each physical extent that is determined to be exclusively accessible to the parent snapshot, removing the physical extent; and
for each physical extent that is determined to be not exclusively accessible to the parent snapshot, taking no action on the physical extent so that the physical extent is used by the running point.

10. The non-transitory computer-readable storage medium of claim 9, wherein the extent ownership value for each physical extent is a monotonically increased value.

11. The non-transitory computer-readable storage medium of claim 9, wherein determining whether the physical extent corresponding to the logical block is exclusively accessible to the parent snapshot includes determining whether the extent ownership value of the logical block is found only in the logical map of the parent snapshot.

12. The non-transitory computer-readable storage medium of claim 9, wherein the logical map of the parent snapshot includes extent ownership values assigned to physical extents accessible to the parent snapshot and the logical blocks of the parent snapshot corresponding to the extent ownership values.

13. The non-transitory computer-readable storage medium of claim 9, wherein the extent ownership value for each physical extent is a middle block address that maps a logical block address of a particular logical block to a physical block address of a particular physical extent.

14. The non-transitory computer-readable storage medium of claim 13, wherein the logical map of the parent snapshot includes middle block addresses assigned to physical extents accessible to the parent snapshot and the logical blocks of the parent snapshot corresponding to the middle block addresses.

15. The non-transitory computer-readable storage medium of claim 14, wherein the logical map of the parent snapshot is associated with a middle logical map that provides mapping between the middle block addresses in the logical map of the parent snapshot and physical block addresses of physical extents accessible to the parent snapshot.

16. The non-transitory computer-readable storage medium of claim 9, wherein the logical maps of the parent snapshot and the running point are stored in a B tree structure.

17. A computer system comprising:
a storage system having computer data storage devices;
memory; and
at least one processor configured to:
receive a request to delete a parent snapshot of a running point of a storage object stored in the storage system, wherein the parent snapshot has a minimum extent ownership value of a first value and the running point has a minimum extent ownership value of a second value;
in response to the request to delete the parent snapshot of the running point, change the minimum extent ownership value of the running point from the second value to the first value so that any physical extent with an extent ownership value equal to or greater than the first value is deemed to be owned by the running point;
for each logical block of the parent snapshot, determine whether a physical extent corresponding to the logical block is exclusively accessible to the parent snapshot using logical maps of the parent snapshot and the running point, each of the logical maps providing mapping between logical blocks and physical extents;
for each physical extent that is determined to be exclusively accessible to the parent snapshot, remove the physical extent; and
for each physical extent that is determined to be not exclusively accessible to the parent snapshot, take no action on the physical extent so that the physical extent is used by the running point.

18. The computer system of claim 17, wherein the extent ownership value for each physical extent is a monotonically increased value.

19. The computer system of claim 17, wherein the at least one processor is configured to determine whether the extent ownership value of each logical block is found only in the logical map of the parent snapshot to determine whether the physical extent corresponding to that logical block is exclusively accessible to the parent snapshot.

20. The computer system of claim 17, wherein the extent ownership value for each physical extent is a middle block address that maps a logical block address of a particular logical block to a physical block address of a particular physical extent.
